(19) United States
(12) Patent Application Publication
(10) Pub. No.: US 2026/0161562 A1
(43) Pub. Date: Jun. 11, 2026

(54) Cache circuit and operation method thereof having low power dissipation mechanism with high performance

(71) Applicant: REALTEK SEMICONDUCTOR CORPORATION, Hsinchu (TW)

(72) Inventor: JEONG-FA SHEU, Hsinchu (TW)

(21) Appl. No.: 19/393,360

(22) Filed: Nov. 18, 2025

(30) Foreign Application Priority Data
Dec. 10, 2024 (TW) 113147980

(51) Int. Cl. G06F 12/0802

(52) U.S. Cl. CPC G06F 12/0802; G06F 2212/60

(57) ABSTRACT

A cache circuit is provided. A write counter circuit cyclically generates a counting value in turn corresponding to one of reference values. In an address storage circuit, an address storage demultiplexer receives and writes an valid write address to one of address registers according to the counting value, each of comparison circuits compares a read address content and a stored address content to generate a comparison result, and a priority decoding circuit determines a latest matched comparison result according to the counting value to generate a selection signal. In a data storage circuit, a data storage demultiplexer receives and writes a valid write data corresponding to the valid write address to one of data registers according to the counting value and a selection circuit receives the selection signal to select stored data or read data outputted from a memory to be actual read data.

### BACKGROUND OF THE INVENTION

### 1. Field of the Invention

The present invention relates to a cache circuit and a cache circuit operation method thereof having a low power dissipation mechanism with a high performance.

### 2.Description of Related Art

A memory circuit, e.g., an embedded memory in a chip system, takes at least one clock cycle to be read such that the data cannot be retrieved instantly. However, in some applications, a read-modify-write operation is performed on the memory circuit such that data in a memory address is read, modified and written to such a memory address. In a high bandwidth application, the read-modify-write operation may be performed on the memory circuit in every clock cycle. If no efficient cache mechanism is available, the read-modify-write operation cannot be accurately performed on the memory circuit under the condition that the time of the read operation and the write operation is too long.

### SUMMARY OF THE INVENTION

In consideration of the problem of the prior art, an object of the present invention is to supply a cache circuit and a cache circuit operation method thereof having a low power dissipation mechanism with a high performance.

The present invention discloses a cache circuit having a low power dissipation mechanism with a high performance that includes a write counter circuit, an address storage circuit and a data storage circuit. The write counter circuit cyclically generates a counting value in turn corresponding to one of reference values. The address storage circuit includes a plurality of address registers, an address storage demultiplexer, a plurality of comparison circuits and a priority decoding circuit. Each of the address registers corresponds to one of the reference values and has a stored address content. The address storage demultiplexer receives a valid write address configured to operate a memory circuit and writes the valid write address to one of the address registers according to the counting value. The comparison circuits receive a read address content, and each of the comparison circuits retrieves the stored address content of one of the address registers to be compared with the read address content to generate one of a plurality of comparison results. The priority decoding circuit determines that the comparison results include at least one matched comparison result having a matched value, determines that the at least one matched comparison result includes a latest matched comparison result having a highest priority according to the counting value and generates a selection signal according to one of the comparison circuits that the latest matched comparison result corresponds to. The data storage circuit includes a plurality of data registers, a data storage demultiplexer and a selection circuit. Each of the data registers corresponds to one of the reference values and has a stored data. The data storage demultiplexer receives valid write data that is written to the memory circuit corresponding to the valid write address and writes the valid write data to one of the data registers according to the counting value. The selection circuit receives the selection signal to select the stored data in one of the data registers or read data outputted from the memory circuit to be actual read data according to the selection signal.

The present invention also discloses a cache circuit operation method having a low power dissipation mechanism with a high performance that includes steps outlined below. A counting value is cyclically generated in turn corresponding to one of reference values by a write counter circuit. A valid write address configured to operate a memory circuit is received and written to one of a plurality of address registers included by an address storage circuit according to the counting value by an address storage demultiplexer included by the address storage circuit, wherein each of the address registers corresponds to one of the reference values and has a stored address content. Valid write data that is written to the memory circuit corresponding to the valid write address is received and written to one of a plurality of data registers included by a data storage circuit according to the counting value by a data storage demultiplexer included by the data storage circuit, wherein each of the data registers corresponds to one of the reference values and has a stored data. A read address content is received by a plurality of comparison circuits included by the address storage circuit, and each of the comparison circuits retrieves the stored address content of one of the address registers to be compared with the read address content to generate one of a plurality of comparison results. The comparison results are determined to include at least one matched comparison result having a matched value, the at least one matched comparison result is determined to include a latest matched comparison result having a highest priority according to the counting value and a selection signal is generated according to one of the comparison circuits that the latest matched comparison result corresponds to by a priority decoding circuit included by the address storage circuit. The selection signal is received to select the stored data in one of the data registers or read data outputted from the memory circuit to be actual read data according to the selection signal by a selection circuit included by the data storage circuit.

These and other objectives of the present invention will no doubt become obvious to those of ordinary skill in the art behind reading the following detailed description of the preferred embodiments that are illustrated in the various figures and drawings.

### BRIEF DESCRIPTION OF THE DRAWINGS

FIG. 1 illustrates a block diagram of a memory system according to an embodiment of the present invention.

FIG. 2 illustrates a block diagram of the write counter circuit according to an embodiment of the present invention.

FIG. 3 illustrates a block diagram of the address storage circuit according to an embodiment of the present invention.

FIG. 4 illustrates a block diagram of the data storage circuit according to an embodiment of the present invention.

FIG. 5 illustrates a block diagram of the priority decoding circuit of the address storage circuit according to an embodiment of the present invention.

FIG. 6 illustrates a block diagram of the write counter circuit according to another embodiment of the present invention.

FIG. 7 illustrates a block diagram of the write counter circuit according to yet another embodiment of the present invention.

FIG. 8 illustrates a flow chart of a cache circuit operation method having a low power dissipation mechanism with a high performance according to an embodiment of the present invention.

### DETAILED DESCRIPTION OF THE PREFERRED EMBODIMENTS

An aspect of the present invention is to provide a cache circuit and a cache circuit operation method thereof having a low power dissipation mechanism with high performance to cyclically perform read and write operations on registers disposed in parallel according to the timing count of a write counter circuit, so as to avoid the power dissipation of the moving of the contents, e.g., an address and data, among different registers. Further, no read operation or write operation is performed when a valid bit of either the address or the data is an invalid value to further lower the power dissipation.

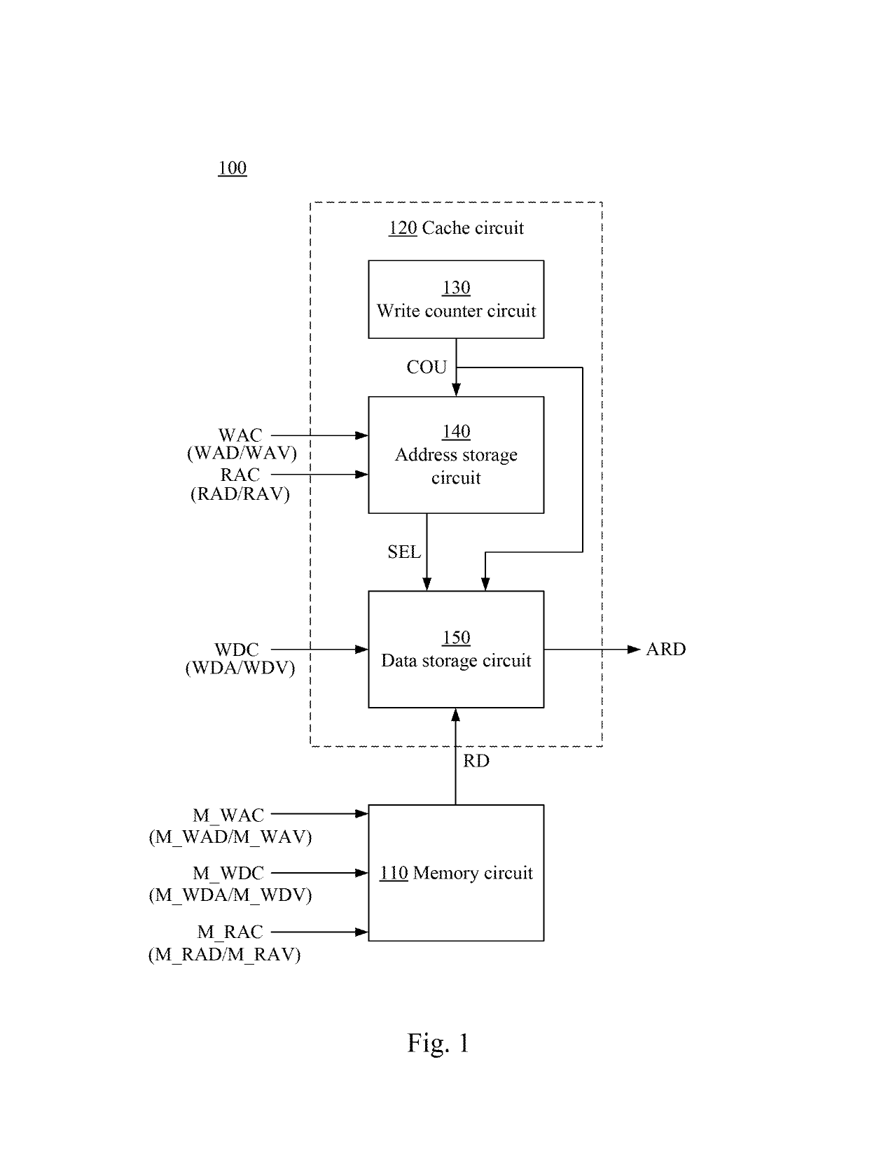

Reference is now made to FIG. 1. FIG. 1 illustrates a block diagram of a memory system 100 according to an embodiment of the present invention. The memory system 100 includes a memory circuit 110 and a cache circuit 120.

The memory circuit 110 receives a write address content M_WAC configured to operate the memory circuit 110 and a write data content M_WDC corresponding to the write address content M_WAC to perform data writing.

More specifically, the write address content M_WAC includes an address M_WAD and an address valid bit M_WAV, wherein the address valid bit M_WAV has a valid value or an invalid value. The write data content M_WDC includes data M_WDA and a data valid bit M_WDV, wherein the data valid bit M_WDV has a valid value or an invalid value. In an embodiment, the valid value is 1 and the invalid value is 0.

The memory circuit 110 determines that the address M_WAD is valid write address when the address valid bit M_WAV has the valid value and determines that the data M_WDA is valid write data when the data valid bit M_WDV has the valid value, so as to write the valid write data M_WDA according to the valid write address M_WAD. When the address valid bit M_WAV has invalid value, the memory circuit 110 determines that the address M_WAD is invalid and does not perform data writing. When the address valid bit M_WAV has the valid value and the data valid bit M_WDV has the invalid value, the memory circuit 110 determines that the data M_WDA is invalid write data and may not perform data writing as well in order to save power. In another embodiment, M_WAV and M_WDV are the same signal coupled together.

On the other hand, the memory circuit 110 receives a read address content M_RAC configured to operate the memory circuit 110 to perform data reading.

More specifically, the read address content M_RAC includes an address M_RAD and an address valid bit M_RAV, wherein the address valid bit M_RAV has a valid value or an invalid value. In an embodiment, the valid value is 1, and the invalid value is 0.

The memory circuit 110 determines that the address M_RAD is a valid read address when the address valid bit M_RAV has the valid value, so as to perform data reading according to such a valid read address M_RAD to generate read data RD. The memory circuit 110 determines that the address M_RAD is an invalid read address when the address valid bit M_RAV has the invalid value and does not perform data reading.

The memory circuit 110 can be such as, but not limited to, an embedded memory within a chip system. It requires at least one clock cycle to complete a read operation such that the data cannot be retrieved instantly. However, in some applications, a read-modify-write operation is performed on the memory circuit 110 such that data in a memory address is read, modified and written to such a memory address. In a high bandwidth application, the read-modify-write operation may be performed on the memory circuit 110 in every clock cycle.

The cache circuit 120 has a low power dissipation mechanism with a high performance to access the data in the memory circuit 110 quickly such that not only the read-modify-write operation can be performed on the memory circuit 110 in every clock cycle, but also a lower power dissipation can be maintained.

The cache circuit 120 receives a write address content WAC and write data content WDC corresponding to the write address content WAC, and also receives a read address content RAC and the read data RD. The write address content WAC, the write data content WDC and the read address content RAC inputted to the cache circuit 120 and the write address content M_WAC, the write data content M_WDC, the read address content M_RAC inputted to the memory circuit 110 have the correspondingly identical contents. In an embodiment, in order to make the timing relations between the signal input of the cache circuit 120 and the signal input and output of the memory circuit 110 synchronous, the timings of the write address content M_WAC and the write data content M_WDC are respectively behind the timings of the write address content WAC and the write data content WDC by one clock cycle, the timing of the read address content RAC is aligned to the timing of the read data RD, and the timing of the read address content M_RAC is ahead of the timing of the read address content RAC by one clock cycle. In another embodiment, the timing of the read address content M_RAC is ahead of the timing of the read address content RAC by two clock cycles. The timing relations of the circuits described above is merely an example and may be different depending on practical requirements. The timing relations, which are not the main issue of the present invention, are well known to those of ordinary skill in the art and are not described herein.

In an embodiment, the cache circuit 120 includes a write counter circuit 130, an address storage circuit 140 and a data storage circuit 150.

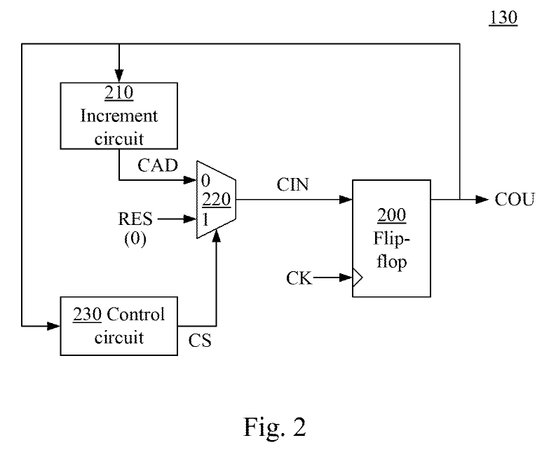

Reference is now made to FIG. 2. FIG. 2 illustrates a block diagram of the write counter circuit 130 according to an embodiment of the present invention. The write counter circuit 130 cyclically generates a counting value COU in turn corresponding to one of reference values. In the present embodiment, the write counter circuit 130 includes a flip-flop 200, an increment circuit 210, a multiplexer 220 and a control circuit 230.

The flip-flop 200, corresponding to a clock signal CK, receives a counting input value CIN and outputs the counting value COU. The increment circuit 210 receives the counting value COU and increments it by a constant –typically, but not limited to, 1– to generate an incremented counting value CAD.

The multiplexer 220 receives the incremented counting value CAD and a reset value RES. In an embodiment, the reset value RES is 0.

The control circuit 230 receives the counting value COU to generate a control signal CS to the multiplexer 220 accordingly. In an embodiment, the control signal CS is at a first state when the counting value COU reaches a threshold value to control the multiplexer 220 to select the reset value RES to be outputted as the counting input value CIN. The control signal CS is at a second state when the counting value COU does not reach the threshold value to control the multiplexer 220 to select the incremented counting value CAD to be outputted as the counting input value CIN. In an embodiment, the first state is a high state and the second state is a low state. However, the present invention is not limited thereto.

The threshold value described above determines the maximum value that the write counter circuit 130 is able to count. In the present embodiment, the condition that the number of stages of the cache registers is 3 is used as an example. As a result, the threshold value is set to be 2. Under such a condition, the reference values include 0, 1 and 2. More specifically, if the counting value COU is 0 in an initial state, the write counter circuit 130 generates the counting value COU in turn corresponding to one of reference values of 0, 1 and 2. When the counting value COU reaches 2, the write counter circuit 130 resets the counting value COU to be 0 to perform the next cycle of counting and keep repeating the operation described above. In another embodiment, the number of stages of the cache registers can be larger than or smaller than 3.

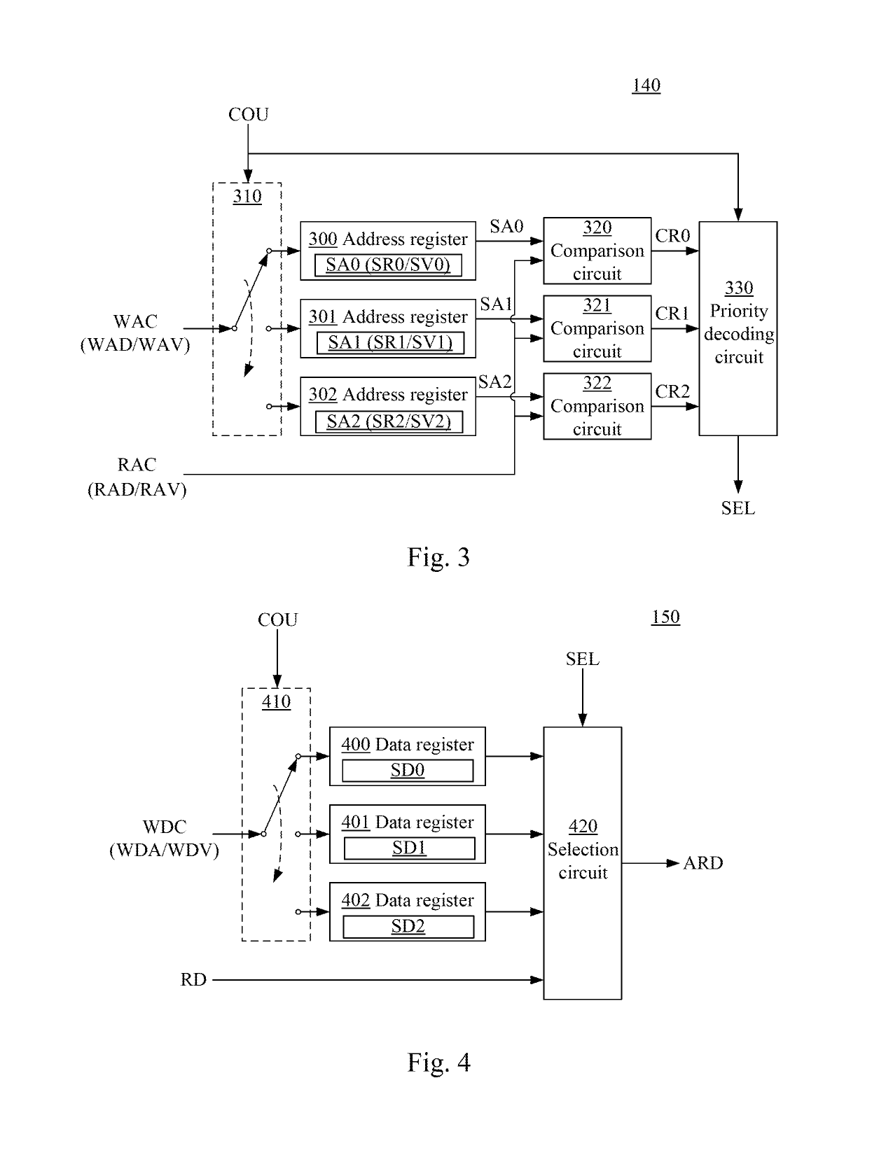

Reference is now made to FIG. 3 and FIG. 4 at the same time. FIG. 3 illustrates a block diagram of the address storage circuit 140 according to an embodiment of the present invention. FIG. 4 illustrates a block diagram of the data storage circuit 150 according to an embodiment of the present invention.

As illustrated in FIG. 3, the address storage circuit 140 includes a plurality of address registers 300~302, an address storage demultiplexer 310, a plurality of comparison circuits 320~322 and a priority decoding circuit 330. As illustrated in FIG. 4, the data storage circuit 150 includes a plurality of data registers 400~402, a data storage demultiplexer 410 and a selection circuit 420.

A writing operation and a read operation can be performed on the address storage circuit 140 and the data storage circuit 150. The configuration and operation of the components related to the write operation are described first in the subsequent paragraphs.

As illustrated in FIG. 3, each of the address registers 300~302 in the address storage circuit 140 corresponds to one of the reference values and has a stored address content SA0~SA2. In the present embodiment, the address registers 300~302 in turn correspond to the reference values of 0, 1 and 2. The stored address content SA0 of the address register 300 includes an address SR0 and an address valid bit SV0. The stored address content SA1 of the address register 301 includes an address SR1 and an address valid bit SV1. The stored address content SA2 of address register 302 includes an address SR2 and an address valid bit SV2.

The address storage demultiplexer 310 of the address storage circuit 140 receives a valid write address configured to operate the memory circuit 110 and write the valid write address to one of the address registers 300~302 according to the counting value COU. In the present embodiment, corresponding to the cyclic incremental counting performed by the write counter circuit 130, the operation of the address storage demultiplexer 310 is described below.

The address storage demultiplexer 310 selects a target address register from the address registers 300~302 according to the counting value COU. More specifically, the address storage demultiplexer 310 selects the address register 300 when the counting value COU is 0, selects the address register 301 when the counting value COU is 1, and selects the address register 302 when the counting value COU is 2. The following paragraphs are described by using the condition that the address storage demultiplexer 310 selects the address registers 300 as the target address register according to the counting value COU that is 0 as an example.

The address storage demultiplexer 310 receives the write address content WAC, wherein the write address content WAC may correspond to a write command of a read-modify-write operation, in which such a write command is used to write modified data to the memory circuit 110 according to the write address content WAC. When the address valid bit WAV included by the write address content WAC has the valid value (e.g., 1), the address storage demultiplexer 310 performs writing on the valid write address WAD included by the write address content WAC to become the address SR0 of the stored address content SA0 of the target address register 300 and set the address valid bit SV0 of the stored address content SA0 of the target address register 300 to be the valid value (e.g., 1).

On the other hand, when the address valid bit WAV included by the write address content WAC has the invalid value (e.g., 0), the address storage demultiplexer 310 does not perform writing on the address WAD included by the write address content WAC in order to save power and sets the address valid bit SV0 of the stored address content SA0 of the target address register 300 to be the invalid value (e.g., 0). As a result, though the counting value COU increments, the address storage demultiplexer 310 only sets the address valid bit SV0 to be the invalid value without actually performing writing.

As illustrated in FIG. 4, each of the data registers 400~402 of the data storage circuit 150 corresponds to one of the reference values and has one of stored data SD0~SD2. In the present embodiment, the data registers 400~402 in turn correspond to the reference values of 0, 1 and 2.

The data storage demultiplexer 410 of the data storage circuit 150 receives valid write data that is written to the memory circuit 110 corresponding to the valid write address and writes the valid write data to one of the data registers 400~402 according to the counting value COU. In the present embodiment, corresponding to the cyclic incremental counting performed by the write counter circuit 130, the operation of the data storage demultiplexer 410 is described below.

The data storage demultiplexer 410 receives the write data content WDC corresponding to the write address content WAC. The write data content WDC can the data M_WDC to be written to the memory circuit 110 according to the write command that the write address content WAC corresponds to.

When the data valid bit WDV that the write data content WDC includes has the valid value (e.g., 1), the data WDA included by the write data content WDC is valid write data. The data storage demultiplexer 410 selects a target data register from the data registers 400~402 according to the counting value COU to performing writing on the valid write data to become the stored data of the target data register. Since the counting value COU is 0 in the embodiment described above, the data storage demultiplexer 410 selects the data register 400 to be the target data register according to the counting value COU that is 0 to perform writing on the valid write data WDA to become the stored data SD0 of the target data register 400.

On the other hand, when the data valid bit WDV included by the write data content WDC has the invalid value (e.g., 0), the data storage demultiplexer 410 does not perform operation. As a result, the target data register 400 does not actually perform data writing.

The configuration and operation of the components related to the read operation are described in the subsequent paragraphs.

As illustrated in FIG. 3, the comparison circuits 320~322 of the address storage circuit 140 receive the read address content RAC, wherein the read address content RAC may correspond to a read command of a next read-modify-write operation, in which such a read command read the data modified previously according to the read address content RAC. Each of the comparison circuits 320~322 correspondingly retrieves one of the stored address content SA0~SA2 of one of the address registers 300~302 to be compared with the read address content RAC to generate one of a plurality of comparison results CR0~CR2. Each of the comparison results CR0~CR2 has a matched value or an unmatched value. In an embodiment, the matched value is 1 and the unmatched value is 0.

Take the comparison circuit 320 as an example, the comparison circuit 320 generates the comparison result CR0 having the matched value only when each of the address valid bit SV0 of the stored address content SA0 and the address valid bit RAV of the read address content RAC has the valid value (e.g., 1) and the address SR0 of the stored address content SA0 and the address RAD of the read address content RAC are the same. When at least one of the address valid bit SV0 and address valid bit RAV has the invalid value (e.g., 0), or when the address SR0 and address RAD are different, the comparison circuit 320 generates has the comparison result CR0 having the unmatched value. The comparison results CR1~CR2 can be generated by the comparison circuits 321~322 based on the identical process. The detail is not described herein.

The priority decoding circuit 330 of the address storage circuit 140 determines that the comparison results CR1~CR2 includes at least one matched comparison result having a matched value, determines that the at least one matched comparison result includes a latest matched comparison result having a highest priority according to the counting value COU and generates a selection signal SEL according to one of the comparison circuits 320~322 that the latest matched comparison result corresponds to.

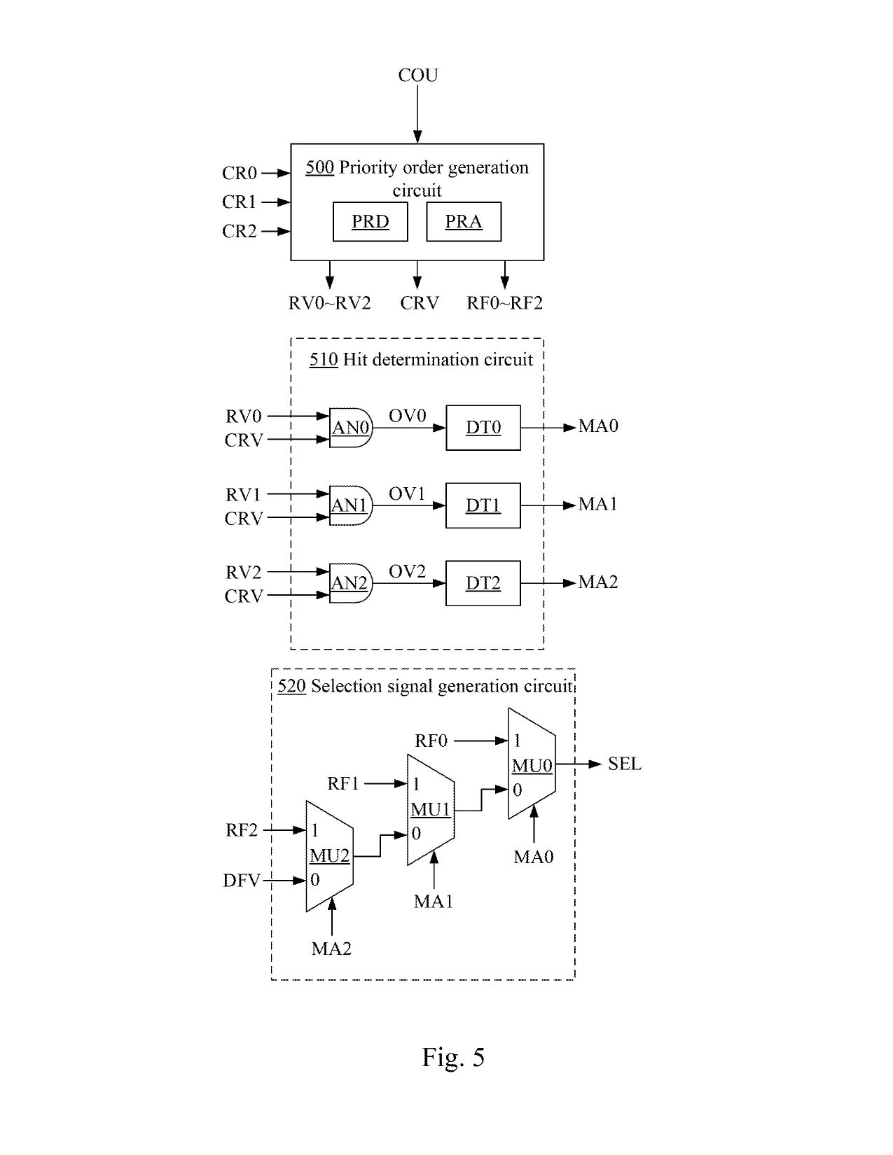

Reference is now made to FIG. 5 at the same time. FIG. 5 illustrates a block diagram of the priority decoding circuit 330 of the address storage circuit 140 according to an embodiment of the present invention. The priority decoding circuit 330 includes a priority order generation circuit 500, a hit determination circuit 510 and a selection signal generation circuit 520.

The priority order generation circuit 500 arranges the reference values from a largest value to a smallest value to generate a predetermined cache priority order PRD from a highest order to a lowest order and cyclically right-shifts the predetermined cache priority order PRD according to the counting value COU to generate an actual cache priority order PRA from the highest order to the lowest order.

In the embodiment described above, the reset value RES of the write counter circuit 130 is 0 and the reference values include 0, 1 and 2. As a result, the priority order generation circuit 500 generates the predetermined cache priority order PRD of (2, 1, 0). Since the address registers 300~302 respectively correspond to the reference values 0, 1 and 2 and have the stored address content SA0~SA2, the order of (2, 1, 0) means that the priority of the stored address content SA0~SA2 from the highest priority to the lowest priority is SA2, SA1 and SA0. When the counting value COU is 0, the priority order generation circuit 500 right-shifts the predetermined cache priority order PRD by 0 bit to generate the actual cache priority order PRA of (2, 1, 0). When the counting value COU is 1, the priority order generation circuit 500 right-shifts the predetermined cache priority order PRD by 1 bit to generate the actual cache priority order PRA of (0, 2, 1). When the counting value COU is 2, the priority order generation circuit 500 right-shifts the predetermined cache priority order PRD by 2 bits to generate the actual cache priority order PRA of (1, 0, 2). In another embodiment, when the reset value RES of the write counter circuit 130 is 1, the reference values include 1, 2 and 3. As a result, the priority order generation circuit 500 generates the predetermined cache priority order PRD of (3, 2, 1).

In an embodiment, the entries included by the actual cache priority order PRA are RF0, RF1 and RF2. More specifically, when the actual cache priority order PRA is (2, 1, 0), the entries RF0, RF1 and RF2 in turn include the reference values 2, 1 and 0. When the actual cache priority order PRA is (0, 2, 1), the entries RF0, RF1 and RF2 in turn include the reference values 0, 2, 1. When the actual cache priority order PRA is (1, 0, 2), the entries RF0, RF1 and RF2 in turn include reference values 1, 0, 2.

The hit determination circuit 510, according to the comparison results CR0~CR2 of all the comparison circuits 320~322, set a plurality of the hit determination values MA0~MA2 for the reference values corresponding to the actual cache priority order PRA, wherein each of the hit determination values MA0~MA2 that corresponds to one of the comparison results CR0~CR2 having the matched value is set to have a hit value and each of the hit determination values MA0~MA2 that corresponds to one of the comparison results CR0~CR2 not having the matched value is set to have a miss value. In an embodiment, the hit value is 1 and the miss value is 0.

The hit determination circuit 510 includes a plurality of logic operation gates AN0~AN2 and a plurality of determining circuits DT0~DT2.

Each of the logic operation gates AN0~AN2 includes a first operation input terminal, a second operation input terminal and an operation output terminal.

The first operation input terminal receives an indication one-dimension vector configured corresponding to a specific reference value of the reference values in the actual cache priority order PRA.

Take the logic operation gate AN0 as an example, the first operation input terminal receives the indication one-dimension vector RV0 configured from the reference value that the entry RF0 in the actual cache priority order PRA corresponds to, which is 2. A plurality of the indication vector elements included by indication one-dimension vector RV0 are arranged according to an arranging order of the reference values, one of the indication vector elements corresponding to the specific reference value has an indication value, and each of the other indication vector elements has a non-indication value. In an embodiment, the indication value is 1 and the non-indication value is 0. In an embodiment, the indication one-dimension vector RV0 is equivalent to left-shift the indication value 1 for a number of bits, in which the number is the reference value that the entry RF0 corresponds to. The indication one-dimension vector RV1 is assigned as 1 shifted left by RF1 bits and the indication one-dimension vector RV2 is assigned as 1 shifted left by RF2 bits.

For example, the indication one-dimension vector RV0 includes three indication vector elements arranged in the arranging order of the reference values 2, 1 and 0. The following description is made by using such a condition as an example. When the specific reference value that the indication one-dimension vector RV0 corresponds to is 2, the first indication vector element is 1, which means that the indication one-dimension vector RV0 indicates the reference value of 2. The second indication vector element is 0, which means that the indication one-dimension vector RV0 does not indicate the reference value of 1. The third indication vector element is 0, which means that the indication one-dimension vector RV0 does not indicate the reference value of 0. As a result, the indication one-dimension vector RV0 is (1, 0, 0).

Similarly, the indication one-dimension vector RV1 received by the first operation input terminal of the logic operation gate AN1 is configured corresponding to the reference value that the entry RF1 corresponds to, which is 1. The indication vector elements (0, 1, 0) respectively mean that the indication one-dimension vector RV1 does not indicate the reference value of 2, indicate the reference value of 1 and does not indicate the reference value of 0. In an embodiment, the indication one-dimension vector RV1 is equivalent to left-shift the indication value 1 by a number of bits, in which the number is the reference value that the entry RF1 corresponds to.

The indication one-dimension vector RV2 received by the first operation input terminal of the logic operation gate AN2 is configured corresponding to the reference value that the entry RF2 corresponds to, which is 0. The indication vector elements (0, 0, 1) respectively mean that the indication one-dimension vector RV1 does not indicate the reference value of 2, does not indicate the reference value of 1 and indicates the reference value of 0. In an embodiment, the indication one-dimension vector RV2 is equivalent to left-shift the indication value 1 by a number of bits, in which the number is the reference value that the entry RF2 corresponds to.

The second operation input terminal receives a comparison result one-dimension vector formed by the comparison results CR0~CR2 of all the comparison circuits 320~322. A plurality of comparison result vector elements included by the comparison result one-dimension vector CRV are arranged according to the arranging order of the reference values in the indication one-dimension vector RV0~RV2 and are denoted by (CR2, CR1, CR0).

Take the indication vector elements of the indication one-dimension vector RV0 that is arranged in the order to the reference values 2, 1 and 0 as an example, the first comparison result vector element of the comparison result one-dimension vector CRV corresponds to the comparison result CR2 related to the reference value 2. The second comparison result vector element of the comparison result one-dimension vector CRV corresponds to the comparison result CR1 related to the reference value 1. The third comparison result vector element of the comparison result one-dimension vector CRV corresponds to the comparison result CR0 related to the reference value 0.

For example, when the comparison result CR2, the comparison result CR1 and the comparison result CR0 respectively contain the unmatched value that is 0, the matched value that is 1 and the matched value that is 1, the resulting one-dimension comparison vector CRV is represented as (0, 1, 1).

The operation output terminal outputs one of output one-dimensional vectors OV0~OV2 generated by performing logic operation on one of the indication one-dimension vectors RV0~RV2 and the comparison result one-dimension vector CRV, wherein each of the output one-dimensional vectors OV0~OV2 includes a plurality of output vector elements. In an embodiment, each of the logic operation gates AN0~AN2 includes 3 AND gates in which each of the first operation input terminal, the second operation input terminal and the operation output terminal of each of the logic operation gates AN0~AN2 has 3 bits.

As a result, under the condition that the comparison result one-dimension vector CRV is (0, 1, 1), the logic operation gate AN0 performs AND logic operation on the indication one-dimension vector RV0 that is (1, 0, 0) and the comparison result one-dimension vector CRV to generate the output one-dimensional vector OV0 that is (0, 0, 0). The logic operation gate AN1 performs AND logic operation on the indication one-dimension vector RV1 that is (0, 1, 0) and the comparison result one-dimension vector CRV to generate the output one-dimensional vector OV1 that is (0, 1, 0). The logic operation gate AN2 performs AND logic operation on the indication one-dimension vector RV2 that is (0, 0, 1) and the comparison result one-dimension vector CRV to generate the output one-dimensional vector OV2 that is (0, 0, 1).

It is appreciated that since the content of the indication one-dimension vectors RV0~RV2 and the comparison result one-dimension vector CRV received by the logic operation gates AN0~AN2 are arranged in the order of the reference values in the actual cache priority order PRA, the indication one-dimension vectors RV0~RV2 and the comparison result one-dimension vector CRV can be generated by the priority order generation circuit 500 according to the actual cache priority order PRA.

The determining circuits DT0~DT2 are configured corresponding to the logic operation gates AN0~AN2. Each of the determining circuits is to output the hit value corresponding to the specific reference value when one of the output vector elements of one of the output one-dimensional vectors OV0~OV2 generated by one of the logic operation gates AN0~AN2 has an enabling value. Each of the determining circuits is to output the miss value corresponding to the specific reference value when each of the output vector elements of one of the output one-dimensional vectors OV0~OV generated by one of the logic operation gates AN0~AN2 has a disabling value. In an embodiment, the enabling value is 1 and the disabling value is 0.

Under the condition that the output one-dimensional vector OV0 is (0, 0, 0), the determining circuit DT0 determines that each of the output vector elements has the disabling value and outputs the hit determination value MA0 having the miss value (e.g., 0) corresponding to the specific reference value that is 2. Under the condition that the output one-dimensional vector OV1 is (0, 1, 0), the determining circuit DT1 determines that the second output vector element has the enabling value and outputs the hit determination value MA1 having the hit value (e.g., 1) corresponding to the specific reference value that is 1. Under the condition that the output one-dimensional vector OV2 is (0, 0, 1), the determining circuit DT2 determines that the third output vector element has the enabling value and outputs the hit determination value MA2 having the hit value (e.g., 1) corresponding to the specific reference value that is 0.

The selection signal generation circuit 520 includes a plurality of select multiplexers MU0~MU2 coupled in series, wherein the N-th select multiplexer has a first select input terminal, a second select input terminal, a select output terminal and a select control terminal.

The first select input terminal receives the N-th reference values in the actual cache priority order PRA. The second select input terminal receives an output value generated by the N+1-th select multiplexer, wherein the second select input terminal of the last select multiplexer receives a predetermined value. The select control terminal receives the N-th hit determination value to select the N-th reference value at the first select input terminal to be outputted to the select multiplexer output terminal when the N-th hit determination value is the hit value, and select the output value at the second select input terminal to be outputted to the select multiplexer output terminal when the N-th hit determination value is the miss value, wherein the select output terminal of the first select multiplexer MU0 outputs the selection signal SEL.

Take the embodiment in FIG. 5 as an example, the first select input terminal of the third select multiplexer MU2 receives the reference value that the third entry RF2 of the actual cache priority order PRA corresponds to. The second select input terminal of the third select multiplexer MU2 receives a predetermined value DFV, wherein the predetermined value DFV is set be such as 3. The select control terminal of the third select multiplexer MU2 receives the third hit determination value MA2. Since the hit determination value MA2 includes the hit value (e.g., 1), the third select multiplexer MU2 selects the reference value (which is 0) that the third entry RF2 of the actual cache priority order PRA corresponds to at the first select input terminal to be outputted to the select output terminal.

The first select input terminal of the second select multiplexer MU1 receives the reference value (which is 1) that the second entry RF1 of the actual cache priority order PRA corresponds to. The second select input terminal of the second select multiplexer MU1 receives the output value (which is 0) that the third select multiplexer MU2 generates. The select control terminal of the second select multiplexer MU1 receives the second hit determination value MA1. Since the hit determination value MA1 includes the hit value (e.g., 1), the second select multiplexer MU1 selects the reference value (which is 1) that the second entry RF1 of the actual cache priority order PRA corresponds to at the first select input terminal to be outputted to the select output terminal.

The first select input terminal of the first select multiplexer MU0 receives the reference value (which is 2) that the first entry RF0 of the actual cache priority order PRA corresponds to. The second select input terminal receives the output value that the second select multiplexer MU1 generates (which is 1, and is the reference value that the second entry RF1 corresponds to). The select control terminal of the first select multiplexer MU0 receives the first hit determination value MA0. Since the hit determination value MA0 includes the miss value (e.g., 0), the first select multiplexer MU0 selects output value (which is 1) that the second select multiplexer MU1 generates at the second select input terminal to be outputted to the select output terminal. The value 1 outputted by the select output terminal of the first select multiplexer serves as the selection signal SEL.

It is appreciated that since the reference values RF0~RF2 received by the select multiplexer MU0~MU2 are in the order of the reference values of the actual cache priority order PRA (in which the priority order from the highest order to the lowest order is the entries RF0, RF1 and RF2), the reference values that the entry RF0~RF2 correspond to can be transmitted to the select multiplexers MU0~MU2 by the priority order generation circuit 500 according to the actual cache priority order PRA.

As illustrated in FIG. 4, the selection circuit 420 of the data storage circuit 150 receives the selection signal SEL to select one of the stored data SD0~SD2 of one of the data registers 400~402 or the read data RD of the memory circuit to be outputted as the actual read data ARD. Under the condition that the data registers 400~402 in turn correspond to the reference values of 0, 1 and 2, when the value of the selection signal SEL is 1, the selection circuit 420 selects the stored data SD1 of the data register 401 corresponding to the reference value 1 to be outputted as the actual read data ARD.

It should be noted that the combination of the matched value and the unmatched value of the comparison results CR0~CR2 described above is provided merely as an example. In other embodiments, different contents of the comparison result one-dimension vector CRV generated based on the different combinations of the matched value and the unmatched value allow the determining circuits DT0~DT2 to generate different combinations of the hit determination values MA0~MA2 such that the selection signal generation circuit 520 generates different values of the selection signal SEL.

In an embodiment, when the condition such as, but not limited to the data in all the cache circuit 120 is outdated such that each of the comparison results CR0~CR2 has the unmatched value, each of the select multiplexers MU0~MU2 of the selection signal generation circuit 520 selects the value at the second select input terminal to be outputted so as to generate the selection signal SEL having the predetermined value DFV. Under such a condition, the selection circuit 420, according to the selection signal SEL having the predetermined value DFV, selects the read data RD read by the memory circuit 110 according to the read address content M_RAC to be outputted as actual read data ARD.

By using the design described above, when the memory circuit 110 is required to perform the read-modify-write operation in every clock cycle, the cache circuit 120 performs the write operation and the read operation described above in an interlace manner so as to provide a quick data accessing mechanism. The latest modified data and the corresponding address in the current clock cycle is written so as to be read for the modification operation performed on the data in the same address in the next clock cycle.

In some approaches, the design of the cache circuit is to couple the register in series to move the data in a sequential manner along with the time, so as to access the register that is disposed more front in the sequence and has the more recent data first to perform the read-modify-write operation. However, in the high bandwidth application usage scenario, when the width of the memory data (e.g., the data WDA and the read data RD) is up to hundreds of bits, the large amount of data moving among the registers coupled in series in every clock cycle consumes a lot of power.

The cache circuit of the present invention cyclically performs read and write operations on registers disposed in parallel according to a timing counting of a write counter circuit, so as to avoid the power dissipation of the moving of the contents, e.g., an address and data, among different registers. Further, no read operation or write operation is performed when a valid bit of either the address or the data is an invalid value to further lower the power dissipation.

In other embodiments, the counting method of the timing used by the cache circuit 120 in FIG. 1 may be modified by using different designs of the write counter circuit to further lower the power dissipation.

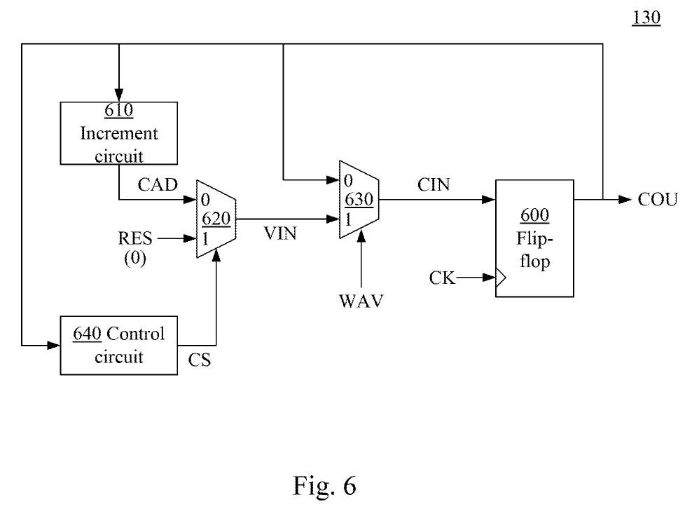

Reference is now made to FIG. 6. FIG. 6 illustrates a block diagram of the write counter circuit 130 according to another embodiment of the present invention. In the present embodiment, the write counter circuit 130 includes a flip-flop 600, an increment circuit 610, a first multiplexer 620, a second multiplexer 630 and a control circuit 640.

The flip-flop 600, corresponding to the clock signal CK, receives the counting input value CIN and outputs the counting value COU. The increment circuit 610 receives and increments the counting value COU according to the constant to generate the incremented counting value CAD. In an embodiment, such a constant is 1. As a result, the counting value COU increments by 1 every time to generate the incremented counting value CAD.

The first multiplexer 620 receives the incremented counting value CAD and the reset value RES. In an embodiment, the reset value RES is 0. The first multiplexer 620 outputs the incremented calibration code VIN. The second multiplexer 630 receives the counting value COU and incremented calibration code VIN.

The control circuit 640 receives the counting value COU and generates the control signal CS to the first multiplexer 620 accordingly. In an embodiment, the control signal CS is at a first state when the counting value COU reaches the threshold value such that the first multiplexer 620 selects the reset value RES to be outputted as the incremented calibration code VIN. The control signal CS is at a second state when the counting value COU does not reach the threshold value such that the first multiplexer 620 selects the incremented counting value CAD to be outputted as the incremented calibration code VIN. In an embodiment, the first state is the high state and the second state is the low state. However, the present invention is not limited thereto. The configuration of the threshold value is identical to the embodiment in FIG. 2 and is not described herein.

The second multiplexer 630 receives the address valid bit WAV of the write address content WAC, selects the incremented calibration code VIN to be outputted as the counting input value CIN when the address valid bit WAV has the valid value (e.g., 1), and selects the counting value COU that is not incremented to be outputted as the counting input value CIN when the address valid bit WAV has the invalid value (e.g., 0).

Under such a condition, the address storage demultiplexer 310 in FIG. 3 selects the target address register from the address registers 300~302 according to the incremented counting value COU when the address valid bit WAV has the valid value to perform writing on the address WAD of the write address content WAC to become the address of the stored address content of the target address register and set the address valid bit of the stored address content of the target address register to be the valid value. The selection of the target address register performed according to the counting value COU and writing process are described in the previous embodiment and are not described herein.

On the other hand, the address storage demultiplexer 310 in FIG. 3 does not update the content of the address register when the address valid bit WAV included by the write address content WAC has the invalid value to save power.

As a result, the write counter circuit 130 in FIG. 6 only increments the counting value COU when the address valid bit WAV has the valid value to further lower the power dissipation of the whole circuit.

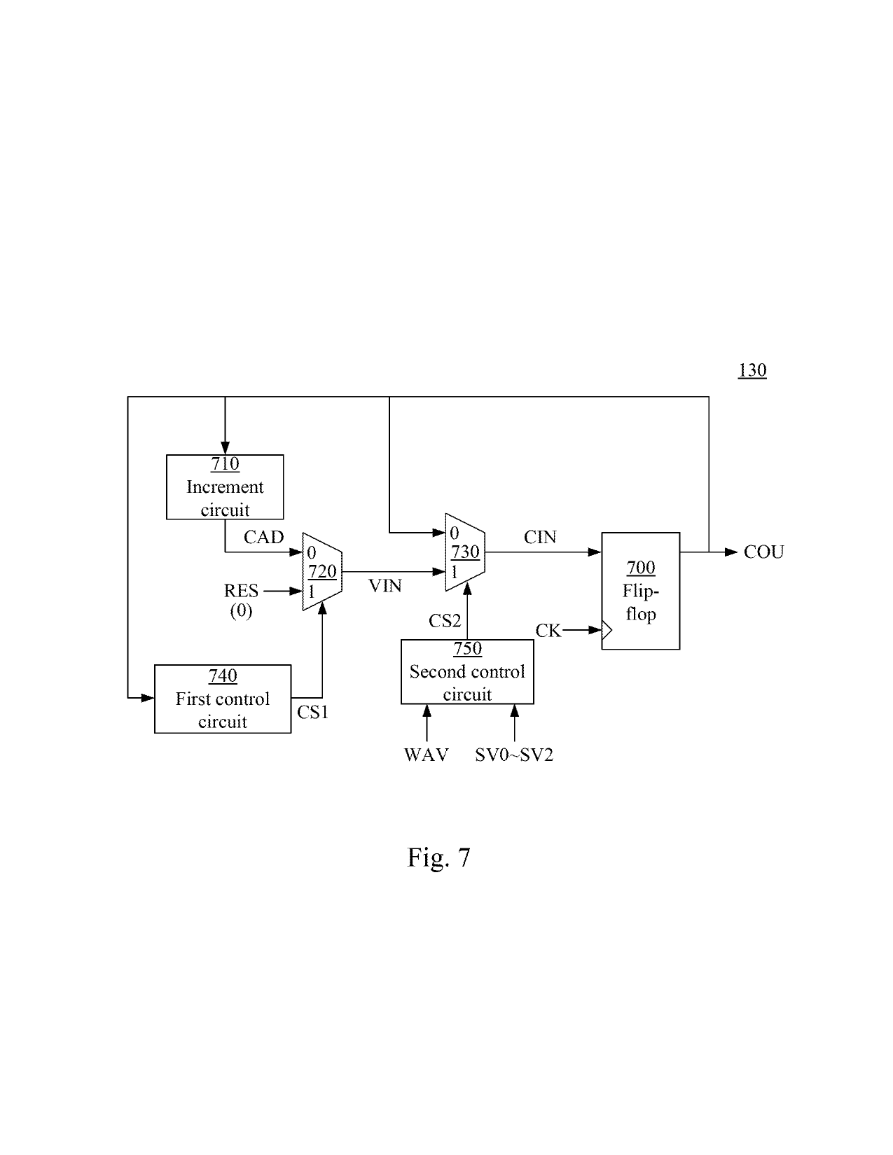

Reference is now made to FIG. 7. FIG. 7 illustrates a block diagram of the write counter circuit 130 according to yet another embodiment of the present invention. In the present embodiment, the write counter circuit 130 includes a flip-flop 700, an increment circuit 710, a first multiplexer 720, a second multiplexer 730, a first control circuit 740 and a second control circuit 750.

The operation of the flip-flop 700, the increment circuit 710, the first multiplexer 720, the second multiplexer 730 and the first control circuit 740 in FIG. 7 is similar to the operation of the flip-flop 600, the increment circuit 610, the first multiplexer 620, the second multiplexer 630 and the control circuit 640 in FIG. 6. The only difference is that the control signal CS generated by the control circuit 640 in FIG. 6 corresponds to the first control signal CS1 generated by the first control circuit 740 in FIG. 7. As a result, the configuration and the operation of these components are not described herein.

In the present embodiment, the second control circuit 750 receives the address valid bit WAV of the write address content WAC and the address valid bits SV0~SV2 of the stored address content SA0~SA2 of all the address registers 300~302 to generate a second control signal CS2 to the second multiplexer 730 accordingly, controls the second multiplexer 730 to select incremented calibration code VIN to be outputted as the counting input value CIN when any one of the address valid bits WAV and SV0~SV2 has the valid value, and controls the second multiplexer 730 to select the counting value COU that is not incremented to be outputted as the counting input value CIN when each of the address valid bit WAV and SV0~SV2 has the invalid value.

Under such a condition, the address storage demultiplexer 310 in FIG. 3 selects the target address register from the address registers 300~302 according to the incremented counting value COU, performs writing on the address WAD of the write address content WAC to become the address of the stored address content of the target address register when the address valid bit WAV of the write address content WAC has the valid value, and sets the address valid bit of the stored address content of the target address register to be the valid value.

The address storage demultiplexer 310 does not perform writing on the address WAD included by the write address content WAC when the address valid bit WAV included by the write address content WAC has the invalid value and when second multiplexer 730 select the incremented calibration code VIN to be outputted as the counting input value, and sets the address valid bit of the stored address content of the target address register to be the invalid value.

The address storage demultiplexer 310 does not perform operation when the address valid bit WAV included by the write address content WAC has the invalid value and when the second multiplexer 730 selects the counting value COU that is not incremented to be outputted as the counting input value CIN.

As a result, the write counter circuit 130 in FIG. 7 only increments the counting value COU when the address valid bit WAV has the valid value or the address stored by any one of the address registers 300~302 is valid to further lower the power dissipation of the whole circuit.

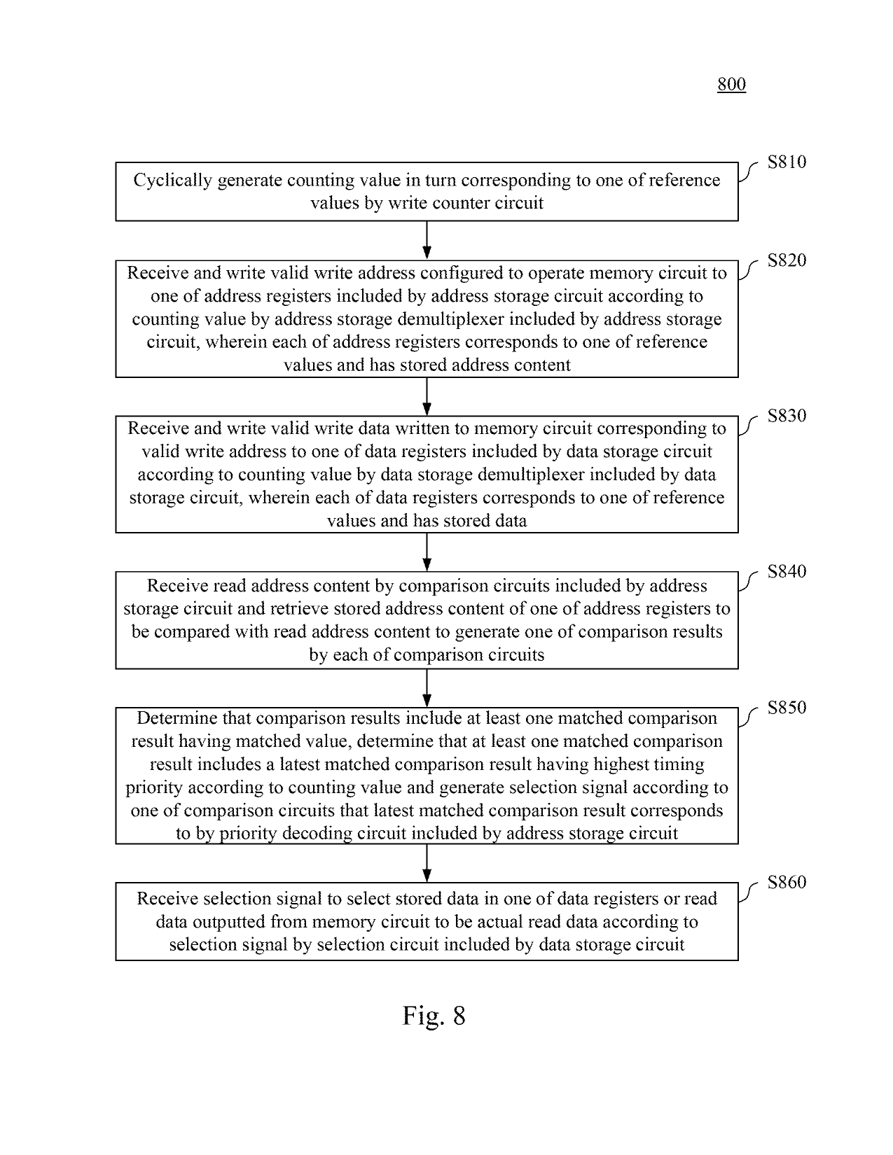

Reference is now made to FIG. 8. FIG. 8 illustrates a flow chart of a cache circuit operation method 800 having a low power dissipation mechanism with a high performance according to an embodiment of the present invention.

In addition to the apparatus described above, the present disclosure further provides the cache circuit operation method 800 having the low power dissipation mechanism with the high performance that can be used in such as, but not limited to, the cache circuit 120 in FIG. 1. As illustrated in FIG. 8, an embodiment of the cache circuit operation method 800 includes the following steps.

In step S810, the counting value COU is cyclically generated in turn corresponding to one of reference values by the write counter circuit 130.

In step S820, the valid write address configured to operate the memory circuit 110 is received and written to one of the address registers 300~302 included by the address storage circuit 140 according to the counting value COU by the address storage demultiplexer 310 included by the address storage circuit 140, wherein each of the address registers 300~302 corresponds to one of the reference values and has one of the stored address content SA0~SA2.

In step S830, the valid write data that is written to the memory circuit 110 corresponding to the valid write address is received and written to one of the data registers 400~402 included by the data storage circuit 150 according to the counting value COU by the data storage demultiplexer 410 included by the data storage circuit 150, wherein each of the data registers 400~402 corresponds to one of the reference values and has one of the stored data SD0~SD2.

In step S840, the read address content RAC is received by the comparison circuits 320~322 included by the address storage circuit 140, and each of the comparison circuits 320~322 retrieves one of the stored address contents SA0~SA2 of one of the address registers 300~302 to be compared with the read address content RAC to generate one of the comparison results CR0~CR2.

In step S850, the comparison results CR0~CR2 are determined to include at least one matched comparison result having the matched value, the at least one matched comparison result is determined to include a latest matched comparison result having the highest timing priority according to the counting value COU and the selection signal SEL is generated according to one of the comparison circuits CR0~CR2 that the latest matched comparison result corresponds to by the priority decoding circuit 330 included by the address storage circuit 140.

In step S860, the selection signal SEL is received to select the stored data in one of the data registers 400~402 or the read data RD outputted from the memory circuit 110 to be the actual read data ARD according to the selection signal SEL by the selection circuit 420 included by the data storage circuit 150.

It is appreciated that the embodiments described above are merely an example. In other embodiments, it should be appreciated that many modifications and changes may be made by those of ordinary skill in the art without departing, from the spirit of the disclosure.

In summary, the present invention discloses the cache circuit and the cache circuit operation method thereof having a low power dissipation mechanism with a high performance cyclically perform read and write operations on registers disposed in parallel according to a timing counting of a write counter circuit, so as to avoid the power dissipation of the moving of the contents, e.g., an address and data, among different registers. Further, no read operation or write operation is performed when a valid bit of either the address or the data is an invalid value to further lower the power dissipation.

The aforementioned descriptions represent merely the preferred embodiments of the present invention, without any intention to limit the scope of the present invention thereto. Various equivalent changes, alterations, or modifications based on the claims of present invention are all consequently viewed as being embraced by the scope of the present invention.

What is claimed is:

1. A cache circuit having a low power dissipation mechanism with a high performance, comprising:
a write counter circuit to cyclically generate a counting value in turn corresponding to one of reference values;
an address storage circuit, comprising:
a plurality of address registers each corresponding to one of the reference values and having a stored address content;
an address storage demultiplexer to receive a valid write address configured to operate a memory circuit and write the valid write address to one of the address registers according to the counting value;
a plurality of comparison circuits to receive a read address content, and each of the comparison circuits retrieves the stored address content of one of the address registers correspondingly to be compared with the read address content to generate one of a plurality of comparison results; and
a priority decoding circuit to determine that the comparison results comprise at least one matched comparison result having a matched value, determine that the at least one matched comparison result comprises a latest matched comparison result having a highest priority according to the counting value and generate a selection signal according to one of the comparison circuits that the latest matched comparison result corresponds to; and
a data storage circuit comprising:
a plurality of data registers each corresponding to one of the reference values and having a stored data;
a data storage demultiplexer to receive valid write data that is written to the memory circuit corresponding to the valid write address and write the valid write data to one of the data registers according to the counting value; and
a selection circuit to receive the selection signal to select the stored data in one of the data registers or read data outputted from the memory circuit to be actual read data according to the selection signal.

2. The cache circuit of claim 1, wherein the priority decoding circuit determines that each of the comparison results has an unmatched value to generate the selection signal having a predetermined value; and
the selection circuit, according to the selection signal having the predetermined value, selects the read data that the memory circuit reads according to the read address content to be the actual read data.

3. The cache circuit of claim 1, wherein the address storage demultiplexer receives a write address content configured to operate the memory circuit, and each of the write address content, the stored address content and the read address content has an address and an address valid bit, the address valid bit having a valid value or an invalid value;
wherein when the address valid bit comprised by the write address content has the valid value, the address comprised by the write address content is the valid write address.

4. The cache circuit of claim 3, wherein the write counter circuit comprises:
a flip-flop to, corresponding to a clock signal, receive a counting input value and output the counting value;
an increment circuit to receive and increment the counting value according to a constant to generate an incremented counting value;
a multiplexer; and
a control circuit to receive the counting value to generate a control signal to the multiplexer accordingly, control the multiplexer to select a reset value to be outputted as the counting input value when the counting value reaches a threshold value and control the multiplexer to select the incremented counting value to be outputted as the counting input value when the counting value does not reach the threshold value;
wherein the address storage demultiplexer is to:
select a target address register from the address registers according to the counting value;
perform writing on the address comprised by the write address content to become the address of the stored address content of the target address register when the address valid bit comprised by the write address content has the valid value, and set the address valid bit of the stored address content of the target address register to be the valid value; and
not perform writing on the address comprised by the write address content when the address valid bit comprised by the write address content has the invalid value and set the address valid bit of the stored address content of the target address register to be the invalid value.

5. The cache circuit of claim 3, wherein the write counter circuit comprises:
a flip-flop to, corresponding to a clock signal, receive a counting input value and output the counting value;
an increment circuit to receive and increment the counting value according to a constant to generate an incremented counting value;
a first multiplexer and a second multiplexer;
a control circuit to receive the counting value and generate a control signal to the first multiplexer accordingly, control the first multiplexer to select a reset value to be outputted as an incremented calibration code when the counting value reaches a threshold value, and control the first multiplexer to select the incremented counting value to be outputted as the incremented calibration code when the counting value does not reach the threshold value; and
wherein the second multiplexer receives the address valid bit of the write address content to select the incremented calibration code to be outputted as the counting input value when the address valid bit of the write address content has the valid value, and select a non-incremented counting value to be outputted as the counting input value when the address valid bit of the write address content has the invalid value;
wherein the address storage demultiplexer is to:
select a target address register from the address registers according to the counting value when the address valid bit of the write address content has the valid value to perform writing on the address comprised by the write address content to become the address of the stored address content of the target address register and set the address valid bit of the stored address content of the target address register to be the valid value; and
not perform operation when the address valid bit of the write address content has the invalid value.

6. The cache circuit of claim 3, wherein the write counter circuit comprises:
a flip-flop to, corresponding to a clock signal, receive a counting input value and output the counting value;
a increment circuit to receive and increment the counting value according to a constant to generate an incremented counting value;
a first multiplexer and a second multiplexer;
a first control circuit to receive the counting value to generate a first control signal to the first multiplexer accordingly, control the first multiplexer to select a reset value to be outputted as an incremented calibration code when the counting value reaches a threshold value, and control the first multiplexer to select the incremented counting value to be outputted as the incremented calibration code when the counting value does not reach the threshold value; and
a second control circuit to receive the address valid bit of the write address content and the address valid bit of the stored address content of each of the address registers to generate a second control signal to the second multiplexer accordingly, control the second multiplexer to select the incremented calibration code to be outputted as the counting input value when either the address valid bit of the stored address content in any of the address registers or the address valid bit of the write address content has the valid value and controls the second multiplexer to select a non-incremented counting value to be outputted as the counting input value when both the address valid bit of the stored address content in each of the address registers and the address valid bit of the write address content have the invalid value;
wherein the address storage demultiplexer is to:
select a target address register from the address registers according to the counting value;
perform writing on the address comprised by the write address content to become the address of the stored address content of the target address register when the address valid bit comprised by the write address content has the valid value and set the address valid bit of the stored address content of the target address register to be the valid value; and
not perform operation when the address valid bit comprised by the write address content has the invalid value.

7. The cache circuit of claim 3, wherein each of the comparison circuits generates one of the comparison results having the matched value only when each of the address valid bit of the stored address content and the address valid bit of the read address content has the valid value and the address of the stored address content is the same as the address of the read address content.

8. The cache circuit of claim 3, wherein the priority decoding circuit comprises:
a priority order generation circuit to arrange the reference values from a largest value to a smallest value to generate a predetermined cache priority order from a highest order to a lowest order and cyclically right-shift the predetermined cache priority order according to the counting value to generate an actual cache priority order from the highest order to the lowest order;
a hit determination circuit, according to the comparison results of all the comparison circuits, set a plurality of hit determination values for the reference values corresponding to the actual cache priority order, wherein each of the hit determination values that corresponds to one of the comparison results having the matched value is set to have a hit value and each of the hit determination values that corresponds to one of the comparison results not having the matched value is set to have a miss value; and
a selection signal generation circuit comprising a plurality of select multiplexers coupled in series, wherein an N-th select multiplexer comprises:
a first select input terminal to receive an N-th reference value in the actual cache priority order;
a second select input terminal to receive an output value generated by an (N+1)-th select multiplexer, wherein the second select input of a last select multiplexer receives a predetermined value;
a select output terminal; and
a select control terminal to receive an N-th hit determination value to select the N-th reference value at the first select input terminal to be outputted to the select multiplexer output terminal when the N-th hit determination value is the hit value, and select the output value at the second select input terminal to be outputted to the select multiplexer output terminal when the N-th hit determination value is the miss value, wherein the select output terminal of a first select multiplexer of the select multiplexers outputs the selection signal.

9. The cache circuit of claim 8, wherein the hit determination circuit comprises:
a plurality of logic operation gates each comprising:
a first operation input terminal to receive an indication one-dimension vector configured corresponding to a specific reference value of the reference values in the actual cache priority order, wherein a plurality of indication vector elements comprised by the indication one-dimension vector are arranged according to an arranging order of the plurality of reference values, one of the indication vector elements corresponding to the specific reference value has an indication value, and each of the other indication vector elements has a non-indication value;
a second operation input terminal to receive a comparison result one-dimension vector formed by the comparison results of all the comparison circuits, wherein a plurality of comparison result vector elements comprised by the comparison result one-dimension vector are arranged according to the arranging order of the reference values; and
an operation output terminal to output an output one-dimensional vector generated by performing logic operation on the indication one-dimension vector and the comparison result one-dimension vector, wherein the output one-dimensional vector comprises a plurality of output vector elements; and
a plurality of determining circuits configured corresponding to the plurality of logic operation gates, each of the determining circuits is to:
output the hit value corresponding to the specific reference value when one of the output vector elements of the output one-dimensional vector generated by one of the logic operation gates has an enabling value; and
output the miss value corresponding to the specific reference value when each of the output vector elements of the output one-dimensional vector generated by one of the logic operation gates has a disabling value.

10. The cache circuit of claim 3, wherein the data storage demultiplexer receives a write data content corresponding to the write address content, the write data content comprising data and a data valid bit and the data valid bit has the valid value or the invalid value;
wherein when the data valid bit comprised by the write data content has the valid value, the data comprised by the write data content is the valid write data, and the data storage demultiplexer selects a target data register from the data registers according to the counting value to perform writing on the valid write data to become the stored data of the target data register; and
when the data valid bit comprised by the write data content has the invalid value, the data storage demultiplexer does not performing operation.

11. A cache circuit operation method having a low power dissipation mechanism with a high performance, comprising:
cyclically generating a counting value in turn corresponding to one of reference values by a write counter circuit;
receiving a valid write address configured to operate a memory circuit and writing the valid write address to one of a plurality of address registers comprised by an address storage circuit according to the counting value by an address storage demultiplexer comprised by the address storage circuit, wherein each of the address registers corresponds to one of the reference values and has a stored address content;
receiving valid write data that is written to the memory circuit corresponding to the valid write address and writing the valid write data to one of a plurality of data registers comprised by a data storage circuit according to the counting value by a data storage demultiplexer comprised by the data storage circuit, wherein each of the data registers corresponds to one of the reference values and has a stored data;
receiving a read address content by a plurality of comparison circuits comprised by the address storage circuit, and each of the comparison circuits retrieves the stored address content of one of the address registers to be compared with the read address content to generate one of a plurality of comparison results;
determining that the comparison results comprise at least one matched comparison result having a matched value, determining that the matched comparison result comprises a latest matched comparison result having a highest priority according to the counting value and generating a selection signal according to one of the comparison circuits that the latest matched comparison result corresponds to by a priority decoding circuit comprised by the address storage circuit; and
receiving the selection signal to select the stored data in one of the data registers or read data outputted from the memory circuit to be actual read data according to the selection signal by a selection circuit comprised by the data storage circuit.

12. The cache circuit operation method of claim 11, further comprising:
determining that each of the comparison results has an unmatched value to generate the selection signal having a predetermined value by the priority decoding circuit; and
according to the selection signal having the predetermined value, selecting the read data that the memory circuit reads according to the read address content to be the actual read data by the selection circuit.

13. The cache circuit operation method of claim 11, wherein the address storage demultiplexer receives a write address content configured to operate the memory circuit, and each of the write address content, the stored address content and the read address content has an address and an address valid bit, the address valid bit having a valid value or an invalid value;
wherein when the address valid bit comprised by the write address content has the valid value, the address comprised by the write address content is the valid write address.

14. The cache circuit operation method of claim 13, further comprising:
corresponding to a clock signal, receiving a counting input value and outputting the counting value by a flip-flop comprised by the write counter circuit;
receiving and incrementing the counting value according to a constant to generate an incremented counting value by an increment circuit comprised by the write counter circuit;
receiving the counting value by a control circuit comprised by the write counter circuit to generate a control signal to a multiplexer comprised by the write counter circuit accordingly, controlling the multiplexer to select a reset value to be outputted as the counting input value by the control circuit comprised by the write counter circuit when the counting value reaches a threshold value and controlling the multiplexer to select the incremented counting value to be outputted as the counting input value by the control circuit comprised by the write counter circuit when the counting value does not reach the threshold value;
selecting a target address register from the address registers according to the counting value by the address storage demultiplexer;
performing writing on the address comprised by the write address content to become the address of the stored address content of the target address register when the address valid bit comprised by the write address content has the valid value, and setting the address valid bit of the stored address content of the target address register to be the valid value by the address storage demultiplexer; and
not perform writing on the address comprised by the write address content when the address valid bit comprised by the write address content has the invalid value and setting the address valid bit of the stored address content of the target address register to be the invalid value by the address storage demultiplexer.

15. The cache circuit operation method of claim 13, further comprising:
corresponding to a clock signal, receiving a counting input value and outputting the counting value by a flip-flop comprised by the write counter circuit;
receiving and incrementing the counting value according to a constant to generate an incremented counting value by an increment circuit comprised by the write counter circuit;
receiving the counting value and generating a control signal to a first multiplexer comprised by the write counter circuit accordingly by a control circuit comprised by the write counter circuit, controlling the first multiplexer to select a reset value to be outputted as an incremented calibration code by the control circuit comprised by the write counter circuit when the counting value reaches a threshold value, and control the first multiplexer to select the incremented counting value to be outputted as the incremented calibration code by the control circuit comprised by the write counter circuit when the counting value does not reach the threshold value; and
receiving the address valid bit of the write address content to select the incremented calibration code to be outputted as the counting input value by a second multiplexer comprised by the write counter circuit when the address valid bit of the write address content has the valid value, and selecting the non-incremented counting value to be outputted as the counting input value by the second multiplexer comprised by the write counter circuit when the address valid bit of the write address content has the invalid value;
selecting a target address register from the address registers according to the counting value when the address valid bit of the write address content has the valid value to perform writing on the address comprised by the write address content to become the address of the stored address content of the target address register and set the address valid bit of the stored address content of the target address register to be the valid value by the address storage demultiplexer; and
not performing operation when the address valid bit of the write address content has the invalid value by the address storage demultiplexer.

16. The cache circuit operation method of claim 13, further comprising:
corresponding to a clock signal, receiving a counting input value and outputting the counting value by a flip-flop comprised by the write counter circuit;
receiving and incrementing the counting value according to a constant to generate an incremented counting value by an increment circuit comprised by the write counter circuit;
receiving the counting value to generate a first control signal to a first multiplexer comprised by the write counter circuit accordingly by a first control circuit comprised by the write counter circuit, controlling the first multiplexer to select a reset value to be outputted as an incremented calibration code by the first control circuit comprised by the write counter circuit when the counting value reaches a threshold value, and control the first multiplexer to select the incremented counting value to be outputted as the incremented calibration code by the first control circuit comprised by the write counter circuit when the counting value does not reach the threshold value;
receiving the address valid bit of the write address content and the address valid bit of the stored address content of each of the address registers to generate a second control signal to the second multiplexer accordingly by a second control circuit comprised by the write counter circuit, controlling the second multiplexer to select the incremented calibration code to be outputted as the counting input value by the second control circuit comprised by the write counter circuit when either the address valid bit of the stored address content in any of the address registers or the address valid bit of the write address content has the valid value and controls the second multiplexer to select the non-incremented counting value to be outputted as the counting input value by the second control circuit comprised by the write counter circuit when both the address valid bit of the stored address content in each of the address registers and the address valid bit of the write address content have the invalid value;
selecting a target address register from the address registers according to the counting value by the address storage demultiplexer;
performing writing on the address comprised by the write address content to become the address of the stored address content of the target address register when the address valid bit comprised by the write address content has the valid value and set the address valid bit of the stored address content of the target address register to be the valid value by the address storage demultiplexer; and
not performing operation when the address valid bit comprised by the write address content has the invalid value by the address storage demultiplexer.

17. The cache circuit operation method of claim 13, further comprising:
generating one of the comparison results having the matched value by each of the comparison circuits only when each of the address valid bit of the stored address content and the address valid bit of the read address content has the valid value and the address of the stored address content is the same as the address of the read address content.

18. The cache circuit operation method of claim 13, further comprising:
arranging the reference values from a largest value to a smallest value to generate a predetermined cache priority order from a highest order to a lowest order and cyclically right-shifting the predetermined cache priority order according to the counting value to generate an actual cache priority order from the highest order to the lowest order by a priority order generation circuit comprised by the priority decoding circuit;
according to the comparison results of all the comparison circuits, setting a plurality of hit determination values for the reference values corresponding to the actual cache priority order by a hit determination circuit comprised by the priority decoding circuit, wherein each of the hit determination values that corresponds to one of the comparison results having the matched value is set to have a hit value and each of the hit determination values that corresponds to one of the comparison results not having the matched value is set to have a miss value;
receiving an N-th reference value in the actual cache priority order by a first select input terminal of an N-th select multiplexer in a plurality of select multiplexers coupled in series comprised by the selection signal generation circuit;
receiving an output value generated by an N+1-th select multiplexer by a second select input terminal of the N-th select multiplexer, wherein the second select input of a last select multiplexer receives a predetermined value; and
receiving an N-th hit determination value by a select control terminal of the N-th select multiplexer to select the N-th reference value at the first select input terminal to be outputted to a select multiplexer output terminal of the N-th select multiplexer when the N-th hit determination value is the hit value, and select the output value at the second select input terminal to be outputted to the select multiplexer output terminal when the N-th hit determination value is the miss value, wherein the select output terminal of a first select multiplexer of the select multiplexers outputs the selection signal.

19. The cache circuit operation method of claim 18, further comprising:
receiving an indication one-dimension vector configured corresponding to a specific reference value of the reference values in the actual cache priority order by a first operation input terminal comprised by each of a plurality of logic operation gates comprised by the hit determination circuit, wherein a plurality of indication vector elements comprised by the indication one-dimension vector are arranged according to an arranging order of the plurality of reference values, one of the indication vector elements corresponding to the specific reference value has an indication value, and each of the other indication vector elements has a non-indication value;
receiving a comparison result one-dimension vector, formed by the comparison results of all the comparison circuits, by a second operation input terminal comprised by each of the logic operation gates, wherein a plurality of comparison result vector elements comprised by the comparison result one-dimension vector are arranged according to the arranging order of the reference values;
outputting an output one-dimensional vector, generated by performing logic operation on the indication one-dimension vector and the comparison result one-dimension vector, by an operation output terminal comprised by each of the logic operation gates, wherein the output one-dimensional vector comprises a plurality of output vector elements;
outputting the hit value corresponding to the specific reference value by each of a plurality of determining circuits configured corresponding to the plurality of logic operation gates when one of the output vector elements of the output one-dimensional vector generated by one of the logic operation gates has an enabling value; and
outputting the miss value corresponding to the specific reference value by each of the determining circuits when each of the output vector elements of the output one-dimensional vector generated by one of the logic operation gates has a disabling value.

20. The cache circuit operation method of claim 13, further comprising:
receiving a write data content corresponding to the write address content by the data storage demultiplexer, the write data content comprising data and a data valid bit and the data valid bit has the valid value or the invalid value;
wherein when the data valid bit comprised by the write data content has the valid value, the data comprised by the write data content is the valid write data, and the data storage demultiplexer selects a target data register from the data registers according to the counting value to perform writing on the valid write data to become the stored data of the target data register; and
when the data valid bit comprised by the write data content has the invalid value, the data storage demultiplexer does not performing operation.
